(19) United States
(12) Patent Application Publication
(10) Pub. No.: US 2008/0250687 A1
(43) Pub. Date: Oct. 16, 2008

(54) Device for Retaining and Fixing a Large Size Advertising Medium Outdoors

(75) Inventor: Matthieu Vanham, Gosselies (BE)

Correspondence Address: SCHMEISER, OLSEN & WATTS, 22 CENTURY HILL DRIVE, SUITE 302, LATHAM, NY, 12110, US

(73) Assignee: VTS S.A., B-6041 Gosselies (BE)

(21) Appl. No.: 12/088,523

(22) PCT Filed: Sep. 8, 2006
(86) PCT No.: PCT/BE2006/000097

§ 371 Date: Mar. 28, 2008

(30) Foreign Application Priority Data
Sep. 30, 2005 (EP) 05447219.6

(51) Int. Cl. G09F 15/00

(52) U.S. Cl. 40/607.1

(57) ABSTRACT

The present invention is related to a device for retaining and fixing an advertising medium outdoors taking the form, for instance, of a canvas, said device comprising a frame (1) delimited by four struts, two lateral struts (2,3), an upper strut and a lower strut (5), each of said struts (2,3,5) being composed of two parallel tubes (6,7) made of appropriate material and joined to each other by means of spacers (8,8′), said retaining device being characterised in that it comprises stabilizing means (100,100′) placed at the bottom of the frame (1) and designed in such a way that the device is able to resist forces exerted by the bad weather and in particular by the wind.

### FIELD OF THE INVENTION

The present invention is related to a device allowing to tend an advertising medium, such as a canvas, outdoors.

### STATE OF THE ART

A very large amount of systems allow the support of large size or very large size advertising elements. Systems described in documents U.S. Pat. No. 5,507,109, FR-2 674 357 and FR-2 622 332 can be quoted as examples.

Large size elements means advertising media taking the form of pictures printed on canvas and having a surface of 5 to 30 m².

For now, the Applicant offers already two types of products allowing the retaining and the fixing of such advertising media.

A first type of devices is meant for indoors applications and is traditionally composed of a frame delimited by four struts: two lateral struts, an upper strut and a lower strut. Each of these struts is composed of two parallel tubes made of an appropriate material and joined to each other by means of a series of spacers disposed diagonally between both of the tubes in order to create a plane for each strut. These tubes can, of course, present a circular section but any other type of section, such as a square section or a triangular section, is also conceivable. Likewise, the spacers have preferably a circular section but other types of section can also be considered. In a particularly advantageous way, the tubes are hollow tubes made of aluminium whereas the spacers can be solid or hollow spacers. Adequately, these spacers are attached to the parallel tubes with appropriate techniques such as the welding or the bolting.

Usually, this type of products is either directly fixed or hung up to wall surfaces, or is provided with a foundation to be laid on a soil at level as it is conceived in most of the constructions.

Another type of products developed by the Applicant consists in offering, but this time outdoors, a device for the retaining and the fixing of such an advertising medium. In comparison with the first type of devices offered by the Applicant, this device is composed, like the first type of device, of a frame whose each strut comprises parallel tubes but the number of parallel tubes per strut is increased. More precisely, in this type of product, each strut comprises three or four parallel tubes which are joined two by two with spacers. Moreover, for outdoors applications, it is planned that at least the lateral struts are fixed permanently to the ground, for example by integrating the ends of said lateral struts to a slab of concrete.

This second type of devices has the advantage, in comparison with the first type of devices, of being able to resist winds having a speed up to 120 km/h, as a result of the increase in the number of tubes and consequently, of spacers. However, this second type of devices presents also the disadvantage of being heavier and more expansive to build than the first type of devices. Indeed, this results from the fact that a device whose struts have each three tubes has, consequently, three times more spacers than a device whose struts have each only two tubes.

Document JP-A-2004/191578 describes a light-weight advertising medium resisting the weathering agents which is made of two identical frames, one of them is placed ahead and the second one is placed at the back. Bars placed perpendicularly to the plane of the frames join the two frames at the four corners, and depending on the size of the medium, also at the middle point of the struts of the frames. This results in a solid structure which is fixed to the ground by a large size tube joined to the lower part of the structure, between both frames. However, this medium has disadvantages: it needs a lot if time to install it, and the tube must be firmly fixed to the ground.

Document U.S. Pat. No. 4,325,197 describes an indoor advertising medium, very easy to install, comprising a frame made of a bar per strut. Moreover, this frame is also equipped with two bars, each of them being located at one of the lower ends placed perpendicularly to the plane of the frame and ensuring a tight fit. The stability of the structure is improved by diagonal struts joining the base bars to the corresponding lateral strut. Unfortunately, this medium can only be used indoors, due to the fragility of the frame as a whole, to the fixing means of the canvas and to the lack in attachment means designed for fixing the base bars to the ground.

### Aims of the Invention

The present invention aims to solve and propose a sophisticated solution to the problem of the state of the art.

Thus, the present invention aims to offer a solution which is aesthetically close to the device proposed for indoors applications but presenting qualities of resistance to the wind and of sufficient solidity for being placed outdoors.

The present invention also aims to offer a solution which has a lightened weight in comparison with current solutions given for outdoors applications.

Secondarily, the present invention also aims to offer a device which presents qualities of fast and efficient assembling and installation.

The present invention also aims to offer a solution which is applicable to any type of foundation: loose soil, concrete, . . . .

### Main Characteristic Elements

The present invention relates to a device for retaining and fixing an advertising medium, for instance, under the form of a canvas, this outdoors, traditionally comprising a frame delimited by four struts, two lateral struts, an upper strut and a lower strut, each of said struts being composed of at least two parallel tubes joined to each other by means of spacers, said retaining device being characterised in that it comprises stabilizing means. These stabilizing means comprise two support elements, each placed at the bottom of one of the lateral struts, perpendicularly to the plane of the frame.

Each support element takes the form of at least two parallel tubes or bars joined to each other with spacers.

The stabilizing means are designed in such a way that the device is able to resist forces exerted by the bad weather, and in particular by the wind.

In other words, the stabilizing means are designed and disposed according to the frame of the device in order to fulfill a function of resistance to the bad weather, and in particular to the wind.

Preferably, each strut and each support element takes the form of two parallel tubes or bars.

Alternatively, each strut and/or each support element takes the form of three parallel tubes or bars. The three parallel tubes or bars are then joined together two by two with spacers.

Preferably, said stabilizing means comprise moreover at least two junction elements allowing to join each support element to the lower part of the frame.

Preferably, said junction elements take the form of at least two tubes or bars from several intersection points and extending in the three orthogonal directions of the space.

Preferably, each junction element takes the form of two parallel tubes or bars joined together with spacers from two intersection points and extending in the three orthogonal directions of the space.

Preferably, said junction elements comprise couplings or connectors joining each of the support elements to one of the lateral struts of the frame and to the lower strut.

The device of the invention is characterised in that each set of two bars joined with spacers constitutes a plane.

Advantageously, the device of the invention is characterised in that it comprises elements said “angle elements” in order to reinforce the whole device and this, only in the planes perpendicular to the plane in which the frame and the advertising medium, positioned on the frame, are disposed, and so allowing to form a set of angles in these two directions.

Said angle elements take advantageously the form of diagonal struts, each diagonal strut joining one of the support elements to the corresponding joining element.

Preferably, the device of the invention is characterised in that an additional element available under the form of a diagonal strut is disposed between the support element and the frame, and this in a plane perpendicular to the plane of the frame.

Preferably, the device of the invention also comprises attachment means which are also used as leveling and stabilizing means for the basic element in order to have it laid at level and fixed adequately to the ground.

Preferably, the device of the invention is characterised in that the parallel tubes are hollow.

Preferably, the device of the invention comprices also, inside the parallel tubes, reinforcement elements, especially reinforcement at the flexure.

Advantageously, the device according to the invention is characterised in that the elements are made of metal, and preferably of aluminium.

Advantageously, the device of the invention is characterised in that the various elements allowing the embodiment of said device are presented under the form of many nestable elements which can be clipped to each other and fixed by means of appropriate attachment means.

### SHORT DESCRIPTION OF THE DRAWINGS

FIG. 1 represents a part of the frame used as retaining support. This is the lower part which is concerned and which comprises the stabilizing means.

FIG. 2 represents only one general perspective view of a stabilizing means and some details of this stabilizing means according to the longitudinal and transversal sections but also from a top view.

FIG. 3 represents in details the attachment elements.

### DESCRIPTION OF A PREFERRED EMBODIMENT OF THE INVENTION

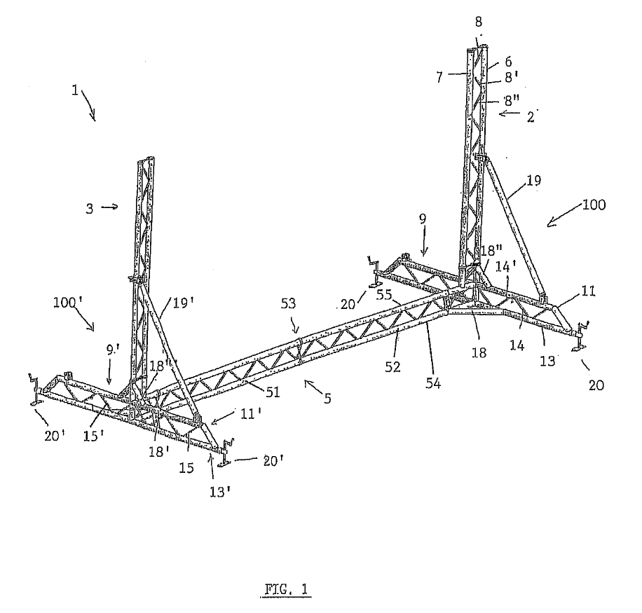

FIG. 1 illustrates a preferred embodiment of the device for retaining and fixing an advertising medium according to the invention, meant for an outdoors use.

As illustrated on FIG. 1, the device is classically composed of a frame 1 delimited by four struts, two lateral struts 2,3, an upper strut and a lower strut 5.

For clarity reasons, only the lower part of the frame linked to the stabilizing means 100, 100′ placed at the base of the frame 1 are showed.

Each of the struts 2,3,5 of the frame 1 is composed of two parallel tubes 6,7 made of an appropriate material and joined to each other by means of spacers 8,8′. Appropriate material means a material which presents properties of mechanical resistance and weight which are compatible with the applications of the device and allowing to minimize its embodiment cost.

Thus, the retaining device according to the invention comprises stabilizing means of the base of the frame. These stabilizing means have the general marks 100 and 100′. They are designed and disposed in accordance to the frame 1 in such a way that the device is able to resist forces exerted by the bad weather, especially by the wind.

These stabilizing means of the base of the frame 100, 100′ are placed at the bottom of each lateral strut 2, 3 of the frame 1.

These stabilizing means 100, 100′ particularly comprise two support elements 9 and 9′, each placed at the bottom of the lateral struts 2 (for the support element 9) or 3 (for the support element 9′) of the frame 1.

Generally, each support element 9, respectively 9′, takes the form of at least one tube or bar 11, respectively 11′, which extends perpendicularly to the plane of the frame 1.

Advantageously, as shown on FIG. 1, each support element 9,9′ takes the form of two tubes or bars which are indicated on FIG. 1 by the marks 11, 13 for the first element 9, and by the marks 11′, 13′ for the second element 9′. These two tubes or bars 11,13 on the one hand, and 11′,13′ on the other hand are advantageously parallel and joined to each other with spacers 14,14′, . . . on the one hand and 15,15′, . . . on the other hand.

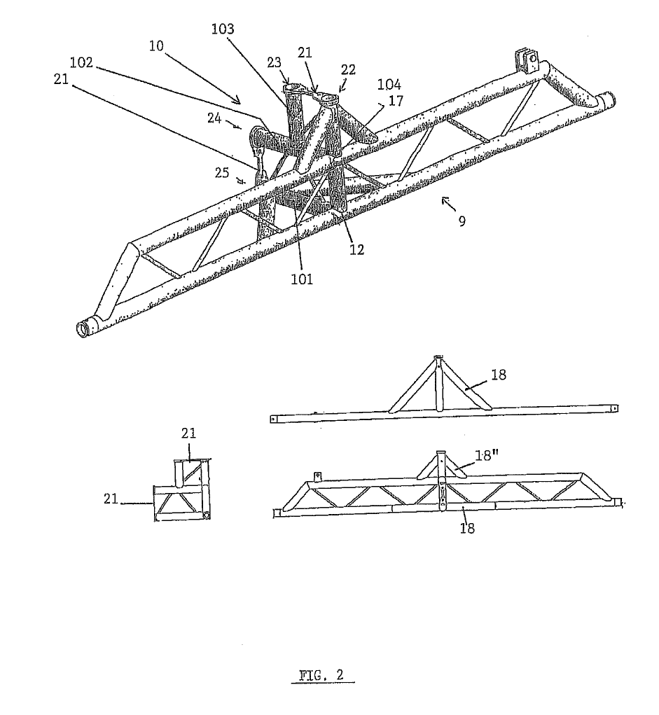

According to the invention, as illustrated on FIG. 1, and in further details on FIG. 2 as far as the stabilization means 100 is concerned, each stabilizing means 100, 100′ respectively, also comprises at least one junction element 10 allowing to join one of the support elements 9, respectively 9′, to the lower part of the frame 1. Each junction element 10, as it can be seen on FIG. 2 for the stabilizing means 100, comprises couplings 22,23,24,25, . . . which extend in the three orthogonal directions of the space and by means of which it ensures its function of link between the support elements 9 or 9′, one of the lateral struts 2 or 3 of the frame 1, and the lower strut 5 of the frame 1.

As shown on FIGS. 1 and 2, in the embodiment comprising two tubes or bars, said couplings 22, 23, 24, 25 of the junction element 10 are disposed within the plane of the frame.

Furthermore, to each of these tubes or bars 6, 7 located at the lateral strut 2 of the frame 1 and to each of the tubes 54, 55 located at the lower strut 5 of the frame 1 corresponds a tube or a bar 101, 102, 103 and 104 located at the junction element 10. The bars 101 and 102 are thus parallel to each other, the bars 103 and 104 are parallel to each other. It is precisely at one of the ends of these tubes or bars 101, 102, 103 and 104 that are located the couplings 22, 23, 24, 25, allowing the junction between the support element 9, the lateral strut 2 and the lower strut 5

It has to be understood that the tubes or bars 101, 102, 103, 104 are located in the extension of the tubes or bars 6, 7 of the lateral strut 2 and of the tubes or bars 54, 55 of the lower strut 5 from the couplings 22, 23, 24, 25 until the support element 9. The parallel tubes or bars 101, 102 join the couplings 24 and 25 to the support element 9 respectively. The parallel tubes or bars 103, 104 join the couplings 23 and 22 to the support element 9 respectively.

It is the same for the junction element 10 located at the stabilizing means 100′ and that allows to link the support element 9′, the lateral strut 3 and the lower strut 5 of the frame 1.

Advantageously, each stabilizing means 100, 100′ also comprises, located at the couplings 22, 23, 24, 25, reinforcement elements 21 joining two by two the parallel tubes or bars 101, 102 at one hand and 103, 104 at the other hand.

The struts 2, 3 and 5 are also advantageously equipped with reinforcement elements 21 located at the couplings.

It will be noted that according to the invention, the junction elements 10 are adapted to the shape of the support elements 9, 9′, i.e. to the above-mentioned embodiment with one or two bars and that, according to this shape, each support element 9, 9′ is connected to a junction element 10, either at the intersection point 12 in the embodiment with one bar, or at two intersection points 12 and 17 in the embodiment with two bars.

It shall be understood that in the device for the retaining and fixing according to the invention each set of two bars 6 and 7; 11 and 13; 11′ and 13′ joined by spacers are forming a plane.

Furthermore, as FIG. 1 shows it, in the device according to the invention the stabilizing means 100, 100′ comprise advantageously elements said “angle elements” 18,18′,18″,18′″ designed to reinforce the whole device in the planes perpendicular to the plane in which are situated the frame 1 and the advertising medium positioned on the device, and therefore forming a set of angles in these two directions.

Thus the angle element 18, taking the form of a diagonal strut, joins the tube 101 of the junction element 10 to the support element 9. Moreover, the angle element 18″ joins the tube 104 of the junction element 10 to the support element 9. Said angle elements reinforce the link between the junction elements 10 and the support elements 9, 9′.

Advantageously as well, the stabilizing means 100, 100′ also comprise one element taking the form of a diagonal strut 19, 19′ connecting in a plane perpendicular to the plane of the frame 1 the support element 9,9′ and the frame 1. More precisely in this case, the diagonal strut 19 joins the support element 9 to the lateral strut 2, while the diagonal strut 19′ joins the support element 9′ to the lateral strut 3.

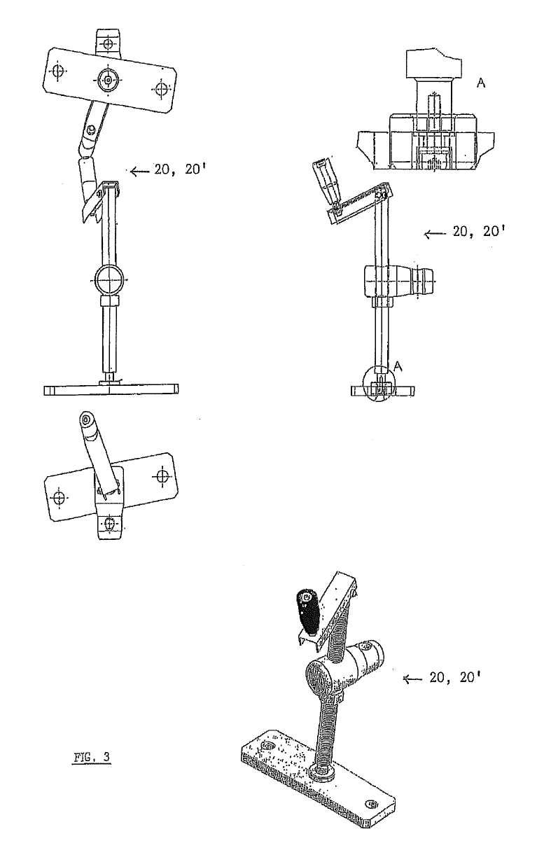

In a particularly advantageous way, as illustrated on FIG. 1, and in further details on FIG. 3, the stabilizing means 100,100′ comprise also attachment means 20,20′ which are also used as leveling and stabilizing means of the support elements 9,9′ and allow to have them at level as fixing them adequately to the ground.

It will be noted that preferably, in order to allow that the device has a minimal weight, the parallel tubes or bars of the device for the retaining and fixing according to the invention are hollow.

According to an alternative embodiment of the invention, the support elements 9, 9′ take advantageously the form of three parallel tubes or bars. Said tubes or bars are joined together two by two with spacers. In this embodiment, the struts 2, 3, 5 as well as the upper strut of the frame 1 take also preferably the form of three parallel tubes or bars joined together two by two with spacers.

It will be noted that in this embodiment with three tubes or bars per strut, the junction elements 10 comprise a coupling for each tube or bar of the lateral and lower struts. These couplings extend in the three directions of the space. Preferably, the couplings are joined together two by two with spacers.

Advantageously, the elements of the device are made of a material not only light but also mechanically and chemically resistant such as, for example, aluminium.

Finally, it will be noted that, according to the invention, the different elements allowing the embodiment of said device take advantageously the form of a series of nestable elements which can be clipped to each other and fixed by means of appropriate attachment means.

In this case, it will also be noted that similarly to the couplings of the junction elements 10, the struts of the frame 1 can take the form of several parts 51 and 52, joined to each other by couplings 53 similar to the couplings 22, 23, 24 and 25.

1-11. (canceled)

12. Device for retaining and fixing an advertising medium outdoors taking the form, for instance, of a canvas, said device comprising a frame delimited by four struts, two lateral struts, an upper strut and a lower strut, each of said struts being composed of at least two parallel tubes joined to each other with spacers, and stabilizing elements comprising two support elements, each of them being placed at the bottom of one of the lateral struts at the bottom of the frame and perpendicularly to the plane of the frame, each support element taking the form of at least two parallel tubes or bars joined to each other with spacers.

13. Device according to claim 12, wherein each strut and each support element take the form of two parallel tubes or bars.

14. Device according to claim 12, wherein the stabilizing elements also comprise at least two junction elements allowing to join each support element to the lower part of the frame, said junction elements comprising couplings which join each of the support elements to one of the lateral struts of the frame and to the lower strut.

15. Device according to claim 13 wherein each set of two parallel tubes or bars joined to each other with spacers constitute a plane.

16. Device according to claim 12, wherein the stabilizing elements also comprise elements referred to as “angle elements” designed to reinforce the whole device in planes perpendicular to the plane in which the frame and the advertising medium positioned on the device are placed, and therefore to form a set of angles in these two directions.

17. Device according to claim 12, wherein the stabilizing elements also comprise two elements, each of them taking the form of a diagonal strut, each diagonal strut connecting in a plane perpendicular to the plane of the frame one of the support elements to one of the lateral struts of the frame.

18. Device according to claim 12, wherein the stabilizing elements also comprise attachment devices which are also used as leveling and stabilizing elements of the support elements in order to have said support elements at level as fixing them adequately to the ground.

19. Device according to claim 12, wherein the parallel tubes or bars are hollow.

20. Device according to claim 12, wherein the stabilizing elements also comprise, located at said couplings, reinforcement elements which join the parallel tubes or bars.

21. Device according to claim 12, wherein the tubes or bars are made of metal.

22. Device according to claim 12, wherein the different elements constituting said device are presented under the form of a series of nestable elements which can be clipped to each other and fixed by attachment devices.
